(19) United States
(12) Patent Application Publication
(10) Pub. No.: US 2024/0326648 A1
(43) Pub. Date: Oct. 3, 2024

(54) SOLAR CHARGING SYSTEM

(71) Applicant: TOYOTA JIDOSHA KABUSHIKI KAISHA, Toyota-shi (JP)

(72) Inventor: Tetsuro NAKAMURA, Nagoya-shi (JP)

(73) Assignee: TOYOTA JIDOSHA KABUSHIKI KAISHA, Toyota-shi (JP)

(21) Appl. No.: 18/595,677

(22) Filed: Mar. 5, 2024

(30) Foreign Application Priority Data
Mar. 29, 2023 (JP) 2023-053354

(51) Int. Cl. B60L 58/20; B60L 1/00; B60L 8/00; B60L 58/13; H02J 7/00

(52) U.S. Cl. CPC B60L 58/20; B60L 1/00; B60L 8/003; B60L 58/13; H02J 7/0024; B60L 2210/10; B60L 2240/80; H02J 2300/24; H02J 2310/48; H02J 2310/60

(57) ABSTRACT

A vehicle is equipped with a drive system and an auxiliary system including one or more auxiliary devices. A solar charging system includes a solar panel and a control unit. The control unit is configured to stop supplying power to the auxiliary system and charging a drive battery in a case in which a charged power to the drive battery is less than a first threshold value and a supplied power to the auxiliary system is less than an average value of the supplied power during a previous charging of the drive battery.

### BACKGROUND

### 1. Field

The present disclosure relates to a solar charging system mounted on a vehicle.

### 2. Description of Related Art

Japanese Laid-Open Patent Publication No. 2021-83248 discloses a solar charging system mounted on a vehicle. The solar charging system includes a solar panel, a drive battery, an auxiliary system, and a control unit. The auxiliary system includes one or more auxiliary devices. The control unit controls the destination of supplying power generated by the solar panel.

The solar charging system supplies power to the auxiliary system when the solar panel is generating power. When the power generated by the solar panel is greater than or equal to a first power, the solar charging system starts charging the drive battery. When the power generated by the solar panel becomes less than or equal to a second power, the solar charging system stops charging the drive battery.

When the solar charging system is activated, various devices in the auxiliary system are activated. Thus, immediately after activation of the solar charging system, the power consumption in the auxiliary system is relatively large. When the power consumption in the auxiliary system is relatively large, most of the power generated by the solar panel is consumed by the auxiliary system. For this reason, in the solar charging system, there exists a possibility that the charging of the drive battery is abruptly stopped soon after activation, resulting in insufficient charging.

### SUMMARY

This Summary is provided to introduce a selection of concepts in a simplified form that are further described below in the Detailed Description. This Summary is not intended to identify key characteristics or essential characteristics of the claimed subject matter, nor is it intended to be used as an aid in determining the scope of the claimed subject matter.

An aspect of the present disclosure provides a solar charging system mounted on a vehicle. The vehicle is equipped with a drive system that drives the vehicle using power stored in a drive battery, and an auxiliary system including one or more auxiliary devices. The solar charging system includes a solar panel and a control unit including processing circuitry. When power is supplied to the auxiliary system and the drive battery is charged, the processing circuitry is configured to stop supplying power to the auxiliary system and charging the drive battery in a case in which a charged power to the drive battery is less than a first threshold value and a supplied power to the auxiliary system is less than an average value of the supplied power during a previous charging of the drive battery.

Other features and aspects will be apparent from the following detailed description, the drawings, and the claims.

### BRIEF DESCRIPTION OF DRAWINGS

FIG. 1 is a schematic diagram illustrating the configuration of a solar charging system according to an embodiment.

FIG. 2 is a diagram illustrating how power is supplied to the auxiliary system and the drive battery is charged in the solar charging system of the embodiment.

FIG. 3 is a timing diagram illustrating changes in the command value of the supplied power to the auxiliary system.

FIG. 4 is a flowchart illustrating the flow of a series of processes executed by the control unit of the solar charging system.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the modes, devices, and/or systems described. Modifications and equivalents of the modes, devices, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

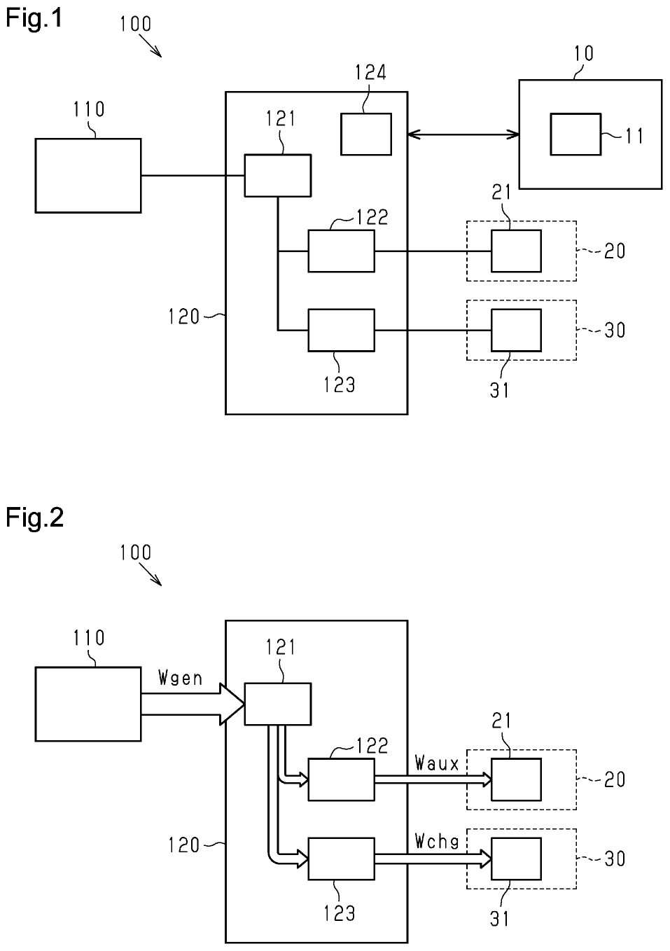

A solar charging system according to an embodiment will now be described with reference to FIGS. 1 to 4.

### Configuration of Solar Charging System 100

As shown in FIG. 1, the solar charging system 100 includes a solar panel 110 and a control unit 120. The solar panel 110 is formed into a panel shape by arranging a solar cells that generate power through irradiation with sunlight. The solar charging system 100 is mounted on a vehicle equipped with a drive system 30 that drives the vehicle using the power stored in a drive battery 31 and equipped with an auxiliary system 20 including one or more auxiliary devices.

The solar panel 110 is installed on the roof of the vehicle, for example. The solar panel 110 may be installed on the hood of the vehicle.

The auxiliary system 20 of the vehicle includes an auxiliary battery 21. The auxiliary system 20 includes auxiliary devices and controllers that operate using the power of the auxiliary battery 21 and the power generated by the solar panel 110. The auxiliary devices are, for example, electric oil pumps, navigation systems, lamps, and various sensors. The controllers are, for example, controllers that control each auxiliary device, controllers for a driving support system, and controllers for an authentication system. The drive system 30 of the vehicle includes one or more motors for driving the vehicle. The drive system 30 of the vehicle includes the drive battery 31, which supplies power to the motor.

The auxiliary battery 21 is charged with electricity generated by the solar panel 110. The auxiliary battery 21 is, for example, a nickel-metal hydride battery. The auxiliary battery 21 is not limited to a nickel-metal hydride battery and may be another type of battery. The drive battery 31 is a lithium-ion battery. The drive battery 31 is not limited to a lithium-ion battery and may be another type of battery.

### Configuration of Control Unit 120

As shown in FIG. 1, the solar panel 110 is connected to the control unit 120. The auxiliary system 20 and the drive system 30 are also connected to the control unit 120. The control unit 120 includes a first DC-DC converter 121, a second DC-DC converter 122, a third DC-DC converter 123, and a controller 124.

The first DC-DC converter 121 converts the power generated by the solar panel 110. The second DC-DC converter 122 converts the power converted by the first DC-DC converter 121 and supplies the converted power to the auxiliary system 20. The third DC-DC converter 123 converts the power converted by the first DC-DC converter 121 and supplies the converted power to the drive system 30.

The controller 124 controls the first DC-DC converter 121, the second DC-DC converter 122, and the third DC-DC converter 123.

The control unit 120 is connected to the vehicle control unit 10. The vehicle control unit 10 includes a vehicle controller 11. The control unit 120 and the vehicle control unit 10 are connected to each other in a communicable manner. The vehicle control unit 10 controls the auxiliary system 20 and the drive system 30.

The vehicle controller 11 acquires an input current to the auxiliary battery 21 and an output current from the auxiliary battery 21 in the auxiliary system 20. The vehicle controller 11 calculates the power consumption in the auxiliary system 20 based on the acquired input current or output current, the voltage of the auxiliary battery 21, and the power supplied from the solar panel 110. The vehicle controller 11 calculates the state of charge of the auxiliary battery 21. The vehicle controller 11 acquires an input current to the drive battery 31 and an output current from the drive battery 31 in the drive system 30. The vehicle controller 11 calculates the power consumption in the drive system 30 based on the acquired input current or output current and the voltage of the drive battery 31. The vehicle controller 11 calculates the state of charge of the drive battery 31.

The vehicle control unit 10 sets a target value of the state of charge of the auxiliary battery 21. Then, the vehicle control unit 10 calculates a command value of a supplied power Waux for maintaining the state of charge at a target level, which is a fixed range including the target value, and sends the command value to the control unit 120. The control unit 120 measures the current and the voltage of the power input to the first DC-DC converter 121 and calculates a generated power Wgen of the solar panel 110.

As shown in FIG. 2, the generated power Wgen is the power generated by the solar panel 110. The supplied power Waux is the power converted by the second DC-DC converter 122 and supplied to the auxiliary system 20. The control unit 120 that has received the command value from the vehicle control unit 10 controls the second DC-DC converter 122 based on the command value to control the power supplied to the auxiliary system 20 so as to achieve the supplied power Waux corresponding to the command value.

The control unit 120 calculates the difference by subtracting the supplied power Waux from the generated power Wgen. The control unit 120 sets the calculated difference as a charged power Wchg to the drive battery 31. As shown in FIG. 2, the charged power Wchg is the power converted by the third DC-DC converter 123 and charged in the drive battery 31. The control unit 120 controls the third DC-DC converter 123 to achieve the charged power Wchg to charge the drive battery 31.

As shown in FIG. 2, the solar charging system 100 divides the generated power Wgen generated by the solar panel 110 into the supplied power Waux and the charged power Wchg, and supplies them to the auxiliary system 20 and the drive system 30. As described above, the charged power Wchg supplied to the drive battery 31 is the remaining power obtained by subtracting the supplied power Waux supplied to the auxiliary system 20 from the generated power Wgen.

### Changes in Command Value of Supplied Power Waux

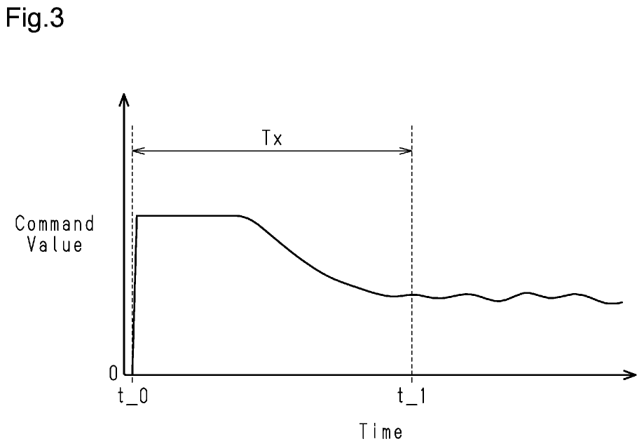

FIG. 3 illustrates changes in the command value of the supplied power Waux to the auxiliary system 20. Time t_0 in FIG. 3 indicates the point in time at which the control unit 120 is activated. When the control unit 120 is activated, the controllers mounted on the vehicle are simultaneously activated together with the controller 124. Then, each activated controller diagnoses whether it is necessary to continue to operate. The controller that has diagnosed that it does not need to continue to operate shifts to a sleep state. In this manner, the controller that is not involved in the control of the solar charging system 100 shifts to the sleep state. Then, the controller related to the control of the solar charging system 100 continues to operate. The controllers related to the control of the solar charging system 100 include, for example, the controller 124 for the control unit 120 and the vehicle controller 11 for the vehicle control unit 10. Immediately after the control unit 120 is activated in this manner, a large number of controllers are activated at the same time. As a result, the power consumption of the auxiliary system 20 increases.

When the control unit 120 shifts to the sleep state, the controllers mounted on the vehicle are simultaneously activated in the same manner as when the control unit 101 is activated. Then, each of the activated controllers diagnoses whether it is necessary to continue to operate. The controller that has diagnosed that it does not need to continue to operate shifts to a sleep state. Thus, the power consumption of the auxiliary system 20 also increases when the control unit 120 shifts to the sleep state. The control unit 120 shifts to the sleep state when the solar panel 110 cannot generate sufficient power. At this time, the power of the auxiliary battery 21 is consumed. Thus, the auxiliary battery 21 needs to be charged in advance with the power to be consumed at this time.

Thus, as shown in FIG. 3, the vehicle control unit 10 sets the command value of the supplied power Waux to a relatively large value in order to cover a relatively large power consumption and to charge the auxiliary battery 21 for a certain period of time after the activation of the control unit 120. The period during which the command value of the supplied power Waux is set to a relatively large value after the activation of the control unit 120 is referred to as a post-activation charging period.

Then, when the controller that does not need to continue to operate shifts to the sleep state to reduce power consumption and charging of the auxiliary battery 21 is completed, the vehicle control unit 10 reduces the command value of the supplied power Waux. As shown in FIG. 3, as the charging of the auxiliary battery 21 approaches completion, the vehicle control unit 10 gradually decreases the command value of the supplied power Waux to terminate the post-activation charging period.

After the post-activation charging period ends, the vehicle control unit 10 calculates the command value of the supplied power Waux so as to maintain the state of charge of the auxiliary battery 21 at the target level as described above.

As described above, in the post-activation charging period immediately after the activation of the solar charging system 100, the supplied power Waux to the auxiliary system 20 is relatively large. Thus, most of the generated power Wgen of the solar panel 110 is consumed by the auxiliary system 20. In the solar charging system 100, the condition for continuing charging may be that the charged power Wchg to the drive battery 31 is greater than or equal to a certain level. However, in this case, there exists a possibility that the charging of the drive battery 31 is abruptly stopped soon after activation, resulting in insufficient charging.

Thus, in the solar charging system 100, charging is stopped on the condition that the charged power Wchg is less than the first threshold value Wx and the supplied power Waux is less than the average value Waux_old of the supplied power Waux.

### Routines Executed by Control Unit 120

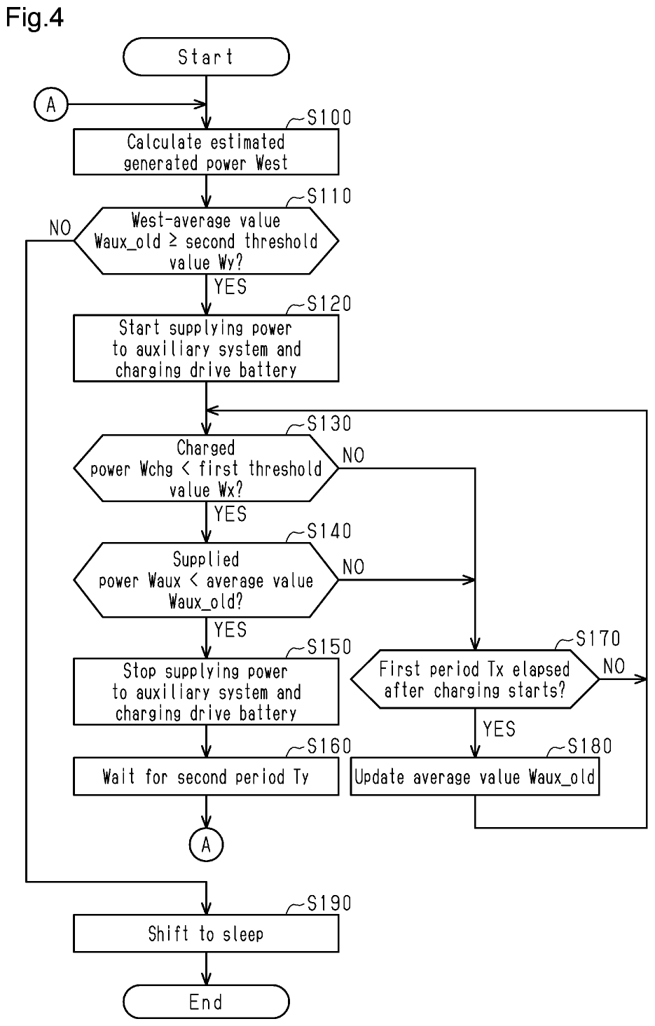

A routine executed by the control unit 120 will now be described with reference to FIG. 4. The routine shown in FIG. 4 is executed by the controller 124 each time the control unit 120 is activated. After shifting to the sleep state, the control unit 120 is activated each time the period of the sleep state reaches a predetermined time. When this routine is started, first, in the process of step S100, the controller 124 calculates the estimated generated power West. The estimated generated power West is an estimated value of the generated power Wgen generated by the solar panel 110. For example, the controller 124 calculates the estimated generated power West based on a closed-circuit voltage and an outflow current of the solar panel 110.

In the next step S110, the controller 124 determines whether the difference obtained by subtracting the average value Waux_old from the estimated generated power West is greater than or equal to the second threshold value Wy. The average value Waux_old is the average value of the power consumption of the auxiliary system 20 during the previous charging of the drive battery 31. The average value Waux_old is calculated in the process of step S180, which will be described later. The second threshold value Wy is a threshold value used for determining whether the solar panel 110 can generate power enough to charge the drive battery 31. The magnitude of the second threshold value Wy is set in advance such that it can be determined that the drive battery 31 can be charged based on the difference being greater than or equal to the second threshold value Wy.

In the process of step S110, when the controller 124 determines that the difference is less than the second threshold value Wy (step S110: NO), the process proceeds to step S190. In this case, the controller 124 causes the control unit 120 to shift to the sleep state without supplying power to the auxiliary system 20 and charging the drive battery 31. Then, the controller 124 ends this routine.

In the process of step S110, when the controller 124 determines that the difference is greater than or equal to the second threshold value Wy (step S110: YES), the process proceeds to step S120.

In the process of step S120, the controller 124 starts supplying power to the auxiliary system 20 and charging the drive battery 31. Specifically, the controller 124 controls the first DC-DC converter 121 and the second DC-DC converter 122 to start supplying power to the auxiliary system 20. The controller 124 controls the supply of power to the auxiliary system 20 based on the command value received from the vehicle control unit 10. As described above, the controller 124 controls the second DC-DC converter 122 in accordance with the command value so as to achieve the supplied power Waux corresponding to the command value.

The controller 124 controls the third DC-DC converter 123 to charge the drive battery 31. As described above, the controller 124 controls the third DC-DC converter 123 such that the remaining power obtained by subtracting the supplied power Waux supplied to the auxiliary system 20 from the generated power Wgen is supplied to the drive battery 31.

In the next step S130, the controller 124 determines whether the charged power Wchg is less than the first threshold value Wx. The first threshold value Wx is a threshold value used for determining that the charged power Wchg of a certain level or higher cannot be ensured. The magnitude of the first threshold value Wx is set in advance such that it can be determined that the charged power Wchg at a certain level or higher cannot be ensured based on the generated power Wgen being less than the first threshold value Wx. For example, the first threshold value Wx is smaller than the second threshold value Wy.

In the process of step S130, when the controller 124 determines that the charged power Wchg is greater than or equal to the first threshold value Wx (step S130: NO), the process proceeds to step S170.

In the process of step S170, the controller 124 determines whether a first period Tx has elapsed from the start of charging of the drive battery 31.

The period from time t_0 to time t_1 in FIG. 3 corresponds to the first period Tx. As shown in FIG. 3, the length of the first period Tx is set to a length that allows for determination that the post-activation charging period, in which the command value for the supplied power Waux is set to a relatively large value, has ended based on the elapsed period from the start of charging being greater than or equal to the first period Tx.

In the process of step S170, when the controller 124 determines that the first period Tx has not elapsed from the start of charging of the drive battery 31 (step S170: NO), the process returns to step S130. In this case, the controller 124 executes the processes subsequent to step S130 again.

In the process of step S170, when the controller 124 determines that the first period Tx has elapsed from the start of charging of the drive battery 31 (step S170: YES), the process proceeds to step S180.

In the process of step S180, the controller 124 updates the average value Waux_old. Specifically, the controller 124 calculates and updates the average value Waux_old based on the supplied power Waux acquired after the elapsed period from the start of charging becomes greater than or equal to the first period Tx. After the average value Waux_old is updated, the process returns to step S130. In this case, the controller 124 executes the processes subsequent to step S130 again.

In the process of step S130, when the controller 124 determines that the charged power Wchg is less than the first threshold value Wx (step S130: YES), the process proceeds to step S140.

In the process of step S140, the controller 124 determines whether the supplied power Waux is less than the average value Waux_old. In the process of step S140, the average value Waux_old is used as a value indicating the level of the power consumption in the auxiliary system 20 at a normal time that is not in the post-activation charging period. That is, the process of step S140 is a process that determines a state in which the supplied power Waux greater than the power consumption in the auxiliary system 20 at the normal time cannot be supplied, in other words, a state in which there is no power to be distributed to charge of the drive battery 31.

The supplied power Waux used in the process of step S140 is acquired by the control unit 120 receiving the value of the power supplied to the auxiliary system 20 from the vehicle control unit 10. That is, the supplied power Waux used in the process of step S140 is an actual measurement value of the power supplied to the auxiliary system 20. The supplied power Waux used in the process of step S140 may be a target value for the control unit 120 to control the supplied power Waux.

In the process of step S140, when the controller 124 determines that the supplied power Waux is greater than or equal to the average value Waux_old (step S140: NO), the process proceeds to step S170. In this case, the controller 124 executes the processes subsequent to step S170.

In the process of step S140, when the controller 124 determines that the supplied power Waux is less than the average value Waux_old (step S140: YES), the process proceeds to step S150.

In the process of step S150, the controller 124 stops supplying power to the auxiliary system 20 and charging the drive battery 31. In the process of the next step S160, the controller 124 waits until the second period Ty elapses. The second period Ty is, for example, several minutes. When the second period Ty has elapsed, the process returns to step S100. Then, the controller 124 executes the processes subsequent to step S100 again.

In this manner, in the solar charging system 100, charging is stopped on the condition that the charged power Wchg is less than the first threshold value Wx and the supplied power Waux is less than the average value Waux_old of the supplied power Waux.

### Operation of Present Embodiment

The control unit 120 stops charging the drive battery 31 in a case in which the charged power Wchg is less than the first threshold value Wx and the supplied power Waux is less than the average value Waux_old.

When the supplied power Waux to the auxiliary system 20 is less than the average value Waux_old, there is a high probability that the power consumption cannot be covered only by the supplied power Waux from the solar charging system 100. In other words, at this time, there is a high probability that the electricity generated by the solar panel 110 cannot be distributed to the charging of the drive battery 31.

The charged power Wchg to the drive battery 31 being less than the first threshold value Wx is a condition for determining that the charged power Wchg greater than or equal to a certain level cannot be ensured. The supplied power Waux to the auxiliary system 20 being less than the average value Waux_old is a condition for determining that there is a high probability that the electricity generated by the solar panel 110 cannot be distributed to the charging of the drive battery 31.

Even if it is determined that the charged power Wchg greater than or equal to a certain level cannot be ensured, the solar charging system 100 does not stop charging only by that determination. The solar charging system 100 continues charging until there is a high probability that the electricity generated by the solar panel 110 cannot be distributed to the charging of the drive battery 31. Thus, in the solar charging system 100, charging is readily continued as compared with a solar charging system in which charging is stopped only based on the charged power Wchg to the drive battery 31 being less than the first threshold value Wx.

### Advantages of Present Embodiment

(1) In the solar charging system 100, charging is readily continued even when the power consumption of the auxiliary system 20 immediately after activation is relatively large. This allows the solar charging system 100 to prevent the drive battery 31 from being insufficiently charged due to an abrupt stop of the charging of the drive battery 31 soon after activation.

(2) The processes in steps S100 to S120 and S190 correspond to the start determination. When activated, the control unit 120 executes the start determination. In the start determination, the control unit 120 calculates the estimated generated power West. In the start determination, when the difference obtained by subtracting the average value Waux_old from the estimated generated power West is greater than or equal to the second threshold value Wy, the control unit 120 starts supplying power to the auxiliary system 20 and charging the drive battery 31. In the start determination, when the difference is less than the second threshold value Wy, the control unit 120 shifts to the sleep state.

The difference obtained by subtracting the average value Waux_old from the estimated generated power West being greater than or equal to the second threshold value Wy indicates a state in which power that is greater than or equal to the second threshold value Wy can be distributed to the charging of the drive battery 31 while the power consumption of the auxiliary system 20 is covered.

The solar charging system 100 shifts to the sleep state when the solar charging system 100 is in a state in which power that is greater than or equal to the second threshold value Wy cannot be distributed to the charging of the drive battery 31. That is, when a certain amount of power cannot be distributed to the drive battery 31, the solar charging system 100 shifts to the sleep state to reduce the power consumption. The solar charging system 100 shifts to the sleep state when the system cannot perform efficient charging. Thus, the power consumption is reduced.

(3) If charging of the drive battery 31 is stopped when the supplied power Waux to the auxiliary system 20 immediately after activation is relatively large, the average value Waux_old becomes a relatively large value. When such a large average value Waux_old is used for the start determination, the supply of power to the auxiliary system 20 and charging of the drive battery 31 are less likely to be started.

The solar charging system 100 does not calculate or update the average value Waux_old when the elapsed period from the start of charging the drive battery 31 is less than the first period Tx. The solar charging system 100 calculates and updates the average value Waux_old based on the supplied power Waux acquired after the elapsed period becomes greater than or equal to the first period Tx. This prevents situations in which the supply of power to the auxiliary system 20 and the charging of the drive battery 31 become difficult to start due to an increase in the average value Waux_old.

(4) The generated power Wgen of the solar panel 110 varies depending on the amount of solar radiation. Thus, even if the amount of solar radiation temporarily decreases and charging stops, the amount of solar radiation may be immediately recovered thereafter and charging may become possible.

The solar charging system 100 executes the start determination again when the second period Ty elapses after the supply of power to the auxiliary system 20 and the charging to the drive battery 31 are stopped. That is, even if the solar charging system 100 stops charging, the solar charging system 100 performs the start determination again without shifting to the sleep state. Thus, even when charging is temporarily stopped, charging is quickly resumed if the battery is restored to a chargeable state during the second period Ty.

The solar charging system 100 prevents the shift to the sleep state and the activation from the sleep state from being repeated. This allows the solar charging system 100 to reduce the power consumption due to the shift to the sleep state and the power consumption due to the activation from the sleep state.

(5) In the solar charging system 100, the control unit 120 controls the supplied power Waux based on the command value in order to maintain the state of charge of the auxiliary battery 21 calculated by the vehicle control unit 10 at the target level. This allows the solar charging system 100 to control the supplied power Waux so as to maintain the state of charge of the auxiliary battery 21 at the target level.

(6) The power consumption by the auxiliary system 20 varies depending on the number and types of features mounted on the vehicle. The power consumption by the auxiliary system 20 also varies depending on how the user is using the vehicle. For example, in the case of a user who frequently uses an air conditioner, the power consumption by the auxiliary system 20 is relatively large. The power consumption by the auxiliary system 20 also gradually changes due to aged deterioration. In the solar charging system 100, the average value Waux_old is used as an index value of the power consumption in the auxiliary system 20 at the normal time in the processes of step S110 and step S140. The solar charging system 100 executes the processes of step S110 and step S140 using the latest average value Waux_old relatively close to the actual power consumption in the normal state. This allows the solar charging system 100 to perform an accurate determination corresponding to a change in the power consumption at the normal state due to the number and types of features of the vehicle, use mode of the user, aged deterioration, or the like.

### Modifications

The present embodiment may be modified as follows. The present embodiment and the following modifications can be combined as long as they remain technically consistent with each other.

The solar charging system 100 may include multiple solar panels 110. In this case, the control unit 120 includes multiple DC-DC converters similar to the first DC-DC converter 121 so as to correspond to the solar panels 110, respectively.

The controller 124 and the vehicle controller 11 may be circuitry including one or more processors that execute various processes in accordance with a computer program (software). The controller 124 and the vehicle controller 11 may be circuitry including one or more dedicated hardware circuits such as application specific integrated circuits (ASICs) that execute at least part of various processes or including a combination thereof. The processor includes a CPU and memories, such as a RAM and a ROM. The memory stores program codes or instructions configured to cause the CPU to execute the processes. The memory, or a computer-readable medium, includes any type of medium that is accessible by general-purpose computers and dedicated computers.

1. A solar charging system mounted on a vehicle, wherein
the vehicle is equipped with:
a drive system that drives the vehicle using power stored in a drive battery; and
an auxiliary system including one or more auxiliary devices,
the solar charging system comprises:
a solar panel; and
a control unit including processing circuitry, and
when power is supplied to the auxiliary system and the drive battery is charged, the processing circuitry is configured to stop supplying power to the auxiliary system and charging the drive battery in a case in which a charged power to the drive battery is less than a first threshold value and a supplied power to the auxiliary system is less than an average value of the supplied power during a previous charging of the drive battery.

2. The solar charging system according to claim 1, wherein
the processing circuitry is configured to:
calculate an estimated generated power when the control unit is activated, the estimated generated power being an estimated value of a generated power of the solar panel;
start supplying power to the auxiliary system and charging the drive battery when a difference obtained by subtracting the average value of the supplied power to the auxiliary system during the previous charging of the drive battery from the estimated generated power is greater than or equal to a second threshold value; and
execute a start determination for shifting to a sleep state when the difference is less than the second threshold value.

3. The solar charging system according to claim 2, wherein
the processing circuitry is configured not to calculate and update the average value when an elapsed period from start of power supply to the auxiliary system and charging of the drive battery is less than a first period, and configured to calculate and update the average value based on the supplied power after the elapsed period becomes greater than or equal to the first period.

4. The solar charging system according to claim 2, wherein
the processing circuitry is configured to execute the start determination again when a second period elapses after stopping supplying power to the auxiliary system and charging the drive battery.

5. The solar charging system according to claim 1, wherein
the vehicle includes a vehicle control unit that controls the auxiliary system and the drive system,
the auxiliary system includes an auxiliary battery, and
the vehicle control unit is configured to:
calculate a state of charge of the auxiliary battery and calculate a command value of the supplied power for maintaining the state of charge at a target level; and
control the supplied power based on the command value calculated by the vehicle control unit.
